(19) United States
(12) Patent Application Publication
(10) Pub. No.: US 2022/0166066 A1
(43) Pub. Date: May 26, 2022

(54) ELECTROLYTE COMPOSITION CONTAINING A MIXTURE OF LITHIUM SALTS

(71) Applicant: Arkema France, Colombes (FR)

(72) Inventor: Grégory SCHMIDT, Pierre-Benite Cedex (FR)

(73) Assignee: Arkema France, Colombes (FR)

(21) Appl. No.: 17/594,258

(22) PCT Filed: May 19, 2020
(86) PCT No.: PCT/FR2020/050829

§ 371 Date: Oct. 8, 2021

(30) Foreign Application Priority Data
May 22, 2019 (FR) FR1905387

(51) Int. Cl. H01M 10/0567; H01M 10/0569; H01M 10/0525; H01M 10/0568

(52) U.S. Cl. CPC H01M 10/0567; H01M 10/0569; H01M 2300/0025; H01M 10/0568; H01M 10/0525

(57) ABSTRACT

An electrolyte composition including: lithium 2-trifluoromethyl-4,5-dicyanoimidazolate; lithium bis(fluorosulfonyl)imide; lithium nitrate; at least one additive (A) allowing formation of an SEI passivation layer; and at least one non-aqueous solvent. Also, the use of the electrolyte composition in an electrochemical cell including at least one negative electrode including lithium, and in particular lithium metal, for reducing or eliminating the growth of lithium dendrites on the surface of said electrode.

### FIELD OF THE INVENTION

The present invention relates to an electrolytic composition comprising at least three lithium salts, and to the use thereof in lithium batteries.

The present invention also relates to the use of such an electrolytic composition for reducing the formation of dendrites.

### TECHNICAL BACKGROUND

One of the major challenges in the field of batteries is that of increasing the energy density with a view in particular to improving the autonomy of electric vehicles. One of the solutions envisioned is a change of anode materials. Currently, the anode material is generally graphite which has a capacity of 350 mAh/mg. Switching to a lithium metal anode which has a capacity of 3860 mAh/g would make it possible to greatly increase the energy density of Li-ion batteries. There are several Li-ion batteries comprising a lithium metal anode: “conventional” lithium-ion batteries or Li-sulfur batteries.

However, Li-ion batteries comprising a lithium metal anode are not sold at this stage because of battery life problems mainly linked to the formation of dendrites. A dendrite is a lithium filament that is created when the battery is charged. This filament can then grow until it passes through the separator and generates a short circuit resulting in the irreversible degradation of the Li-ion battery.

New technologies, such as solid electrolytes or polymer gel electrolytes, have been developed in order to combat these dendrites. However, these two technologies do not make it possible to achieve the performance levels of Li-ion batteries obtained with liquid electrolytes, in particular because of their low ionic conductivity.

There is therefore a need for new electrolytes which at least partially remedy one of the abovementioned drawbacks.

More particularly, there is a need for novel electrolyte compositions which make it possible to reduce or even eliminate the formation of dendrites on the surface of electrodes.

### DESCRIPTION OF THE INVENTION

The present application relates to an electrolyte composition comprising:
lithium 2-trifluoromethyl-4,5-dicyanoimidazolate (LiTDI),
lithium bis(fluorosulfonyl)imide (LiFSI),
lithium nitrate (LiNO₃), and
at least one additive (A) allowing formation of an SEI passivation layer, and
at least one non-aqueous solvent.

In the context of the invention, and unless otherwise mentioned, the terms “electrolyte composition”, “electrolytic composition” and “electrolyte” are used interchangeably.

In the context of the invention, the terms “lithium salt of bis(fluorosulfonyl)imide”, “lithium bis(fluorosulfonyl)imide”, “LiFSI”, “LiN(FSO₂)₂ or “lithium bis(fluorosulfonyl)imide” are used equivalently.

In the context of the invention, the term “SEI” is understood to mean “Solid Electrolyte Interface”, which is a passivation layer that is well known in the field of batteries. Typically, the SEI is a passivation layer which is formed mainly at the anode, and which makes it possible to prevent reduction of the electrolyte. It is typically permeable to the lithium cation for correct operating of the Li-ion battery.

Lithium 2-trifluoromethyl-4,5-dicyanoimidazolate, known under the name LiTDI, has the following structure:

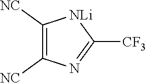

### Composition

Preferably, the electrolyte composition is an electrolyte composition for batteries, and in particular for Li-ion batteries.

The additive (A) allowing the formation of the SEI passivation layer can be chosen from the group consisting of fluoroethylene carbonate (FEC), vinylene carbonate, difluoroethylenecarbonate, 4-vinyl-1,3-dioxolan-2-one, pyridazine, vinyl pyridazine, quinoline, vinyl quinoline, butadiene, sebaconitrile, alkyl disulfides, fluorotoluene, 1,4-dimethoxytetrafluorotoluene, t-butylphenol, di-t-butylphenol, tris(pentafluorophenyl)borane, oximes, aliphatic epoxides, halogenated biphenyls, methacrylic acids, allylethyl carbonate, vinyl acetate, divinyl adipate, acrylonitrile, 2-vinylpyridine, maleic anhydride, methyl cinnamate, phosphonates, vinyl-containing silane compounds, 2-cyanofuran, lithium bis(oxalato)borate (LiBOB), lithium difluoro(oxalato)borate (LiDFOB), LiPO₂F₂, and mixtures thereof.

The additive (A) is preferably chosen from the group consisting of fluoroethylene carbonate (FEC), vinylene carbonate, lithium difluoro(oxalato)borate (LiDFOB), LiPO₂F₂, and mixtures thereof.

Even more preferably, the additive (A) is fluoroethylene carbonate (FEC).

The total weight content of the additive(s) (A) in the electrolyte composition can range from 0.01% to 10%, preferably from 0.1% to 4% by weight relative to the total weight of the composition. Preferentially, the content of additive(s) (A) in the electrolyte composition is less than or equal to 3% by weight, relative to the total weight of the composition.

The electrolyte composition can comprise other electrolyte salts. This may for example be LiTFSI, LiPF₆ or LiBF₄.

Preferably, LiFSI salts, LiTDI and LiNO₃ represent between 2% and 100% by weight of all the salts present in the electrolyte composition, preferably between 25% and 100% by weight, and preferentially between 50% and 100% by weight.

Preferably, the electrolyte composition comprises no alkali metal or alkaline-earth metal salt other than LiFSI, LiTDI and LiNO₃. In particular, the composition does not comprise LiPF₆ or LiTFSI.

The molar concentration of lithium 2-trifluoromethyl-4,5-dicyanoimidazolate (LiTDI) in the electrolyte composition may be less than or equal to 3 mol/l, preferably less than or equal to 2 mol/l, even more preferentially less than or equal to 1 mol/l.

The molar concentration of lithium 2-trifluoromethyl-4,5-dicyanoimidazolate (LiTDI) in the electrolyte composition can be between 0.01 and 3 mol/l, preferably between 0.01 and 2 mol/l, even more preferentially between 0.02 and 1 mol/l.

The molar concentration of lithium bis(fluorosulfonyl)imide (LiFSI) in the electrolyte composition may be less than or equal to 5 mol/l, preferably less than or equal to 4 mol/l, even more preferentially less than or equal to 3 mol/l, and advantageously less than or equal to 2 mol/l.

The molar concentration of lithium bis(fluorosulfonyl)imide (LiFSI) in the electrolyte composition can be between 0.01 and 5 mol/l, preferably between 0.1 and 5 mol/l, even more preferentially between 0.5 and 4 mol/l, for example between 0.5 and 2 mol/l.

The molar concentration of lithium nitrate (LiNO₃) in the electrolyte composition may be less than or equal to 3 mol/l, preferably less than or equal to 2 mol/l, even more preferentially less than or equal to 1 mol/l.

The molar concentration of lithium nitrate (LiNO₃) in the electrolyte composition may be between 0.01 and 3 mol/l, preferably between 0.01 and 2 mol/l, even more preferentially between 0.05 and 1 mol/l.

According to one embodiment, the molar concentrations of LiFSI, LiTDI and LiNO₃ in the electrolyte composition are such that:

[LiFSI]+[LiTDI]+[LiNO₃]≤5 mol/l

advantageously less than or equal to 4 mol/l, preferably less than or equal to 3 mol/l, preferentially less than or equal to 1.5 mol/l.

According to one embodiment, the abovementioned electrolyte composition is such that:
the molar concentration of LiFSI is greater than or equal to 0.05 mol/l,
the molar concentration of LiTDI is greater than or equal to 1.5 mol/l, and
the molar concentration of LiNO₃ is less than or equal to 1.5 mol/l.

The electrolyte composition may comprise a non-aqueous solvent or a mixture of different non-aqueous solvents, such as for example two, three or four different solvents.

The non-aqueous solvent of the electrolyte composition can be a liquid solvent, optionally gelled by a polymer, or a polar polymer solvent optionally plasticized by a liquid.

According to one embodiment, the non-aqueous solvent is an aprotic organic solvent. Preferably, the solvent is a polar aprotic organic solvent.

According to one embodiment, the non-aqueous solvent is chosen from the group consisting of ethers, carbonates, ketones, partially hydrogenated hydrocarbons, nitriles, amides, sulfoxides, sulfolane, nitromethane, 1,3-dimethyl-2-imidazolidinone, 1,3-dimethyl-3,4,5,6-tetrahydro-2(1H)-pyrimidinone, 3-methyl-2-oxazolidinone and mixtures thereof.

Among the ethers, mention may be made of linear or cyclic ethers, such as, for example, dimethoxyethane (DME), methyl ethers of oligoethylene glycols of 2 to 5 oxyethylene units, 1,3-dioxolane (CAS No. 646-06-0), dioxane, dibutyl ether, tetrahydrofuran, and mixtures thereof.

Mention may in particular be made, among the ketones, of cyclohexanone.

Mention may be made, among the nitriles, for example, of acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile and mixtures thereof.

Mention may be made, among the carbonates, par example, of cyclic carbonates, such as, for example, ethylene carbonate (EC), propylene carbonate (PC), butylene carbonate (BC), dimethyl carbonate (DMC), diethyl carbonate (DEC), ethyl methyl carbonate (EMC), diphenyl carbonate, methyl phenyl carbonate, dipropyl carbonate (DPC), methyl propyl carbonate (MPC), ethyl propyl carbonate (EPC), vinylene carbonate (VC) or mixtures thereof.

Preferably, the non-aqueous solvent is chosen from the group consisting of carbonates, ethers and mixtures thereof.

Mention may in particular be made of the following mixtures:
Dimethoxyethane (DME),
Dimethoxyethane/1,3-dioxolane 1/1 by weight,
Dimethoxyethane/1,3-dioxolane 2/1 by weight,
Dimethoxyethane/1,3-dioxolane 3/1 by weight,
Dimethoxyethane/1,3-dioxolane 1/1 by volume,
Dimethoxyethane/1,3-dioxolane 2/1 by volume,
Dimethoxyethane/1,3-dioxolane 3/1 by volume,
Ethylene carbonate/propylene carbonate/Dimethyl carbonate 1/1/1 by weight,
Ethylene carbonate/propylene carbonate/Diethyl carbonate 1/1/1 by weight,
Ethylene carbonate/propylene carbonate/Ethylmethyl carbonate 1/1/1 by weight,
Ethylene carbonate/Dimethyl carbonate 1/1 by weight,
Ethylene carbonate/Diethyl carbonate 1/1 by weight,
Ethylene carbonate/Ethyl methyl carbonate 1/1 by weight,
Ethylene carbonate/Dimethyl carbonate 3/7 by volume,
Ethylene carbonate/Diethyl carbonate 3/7 by volume,
Ethylene carbonate/Ethyl methyl carbonate 3/7 by volume.

Preferably, the abovementioned electrolyte composition comprises dimethoxyethane.

The total weight content of the non-aqueous solvent(s) in the electrolyte composition may be greater than or equal to 40% by weight, preferably greater than or equal to 50% by weight, and advantageously greater than or equal to 60% by weight, relative to the total weight of the composition.

According to one preferred embodiment, the electrolyte composition is such that the additive (A) is different than the non-aqueous solvent.

The electrolyte composition, can be prepared by dissolution, preferably with stirring, of the salts in appropriate proportions of solvent(s) and/or of additive(s).

### Electrochemical Cell

The present application also relates to an electrochemical cell comprising a negative electrode, a positive electrode and an electrolyte composition as defined here above, in particular interposed between the negative electrode and the positive electrode. The electrochemical cell can also comprise a separator, in which the electrolyte composition as defined above is impregnated.

The present invention also relates to a battery comprising at least one electrochemical cell as described above. When the battery comprises several electrochemical cells according to the invention, said cells can be assembled in series and/or in parallel.

In the context of the invention, negative electrode is intended to mean the electrode which acts as anode when the battery produces current (that is to say, when it is in the process of discharging) and which acts as cathode when the battery is in the process of charging.

The negative electrode typically comprises an electrochemically active material, optionally an electronic conductor material, and optionally a binder.

In the context of the invention, the term “electrochemically active material” is intended to mean a material capable of reversibly inserting ions.

In the context of the invention, “electronic conductor material” is intended to mean a material capable of conducting electrons.

According to one preferred embodiment, the negative electrode of the electrochemical cell comprises lithium as electrochemically active material.

More particularly, the negative electrode of the electrochemical cell comprises lithium metal or a lithium-based alloy, which may be in the form of a film or a rod. Among the lithium-based alloys, mention may be made, for example, of lithium-aluminum alloys, lithium-silica alloys, lithium-tin alloys, Li—Zn, Li—Sn, Li₃Bi, Li₃Cd and Li₃SB.

An example of a negative electrode may be an active lithium film prepared by rolling a strip of lithium between rollers.

In the context of the invention, positive electrode is intended to mean the electrode which acts as cathode when the battery produces current (that is to say, when it is in the process of discharging) and which acts as anode when the battery is in the process of charging.

The positive electrode typically comprises an electrochemically active material, optionally an electronic conductor material, and optionally a binder.

The positive electrode of the electrochemical cell may comprise an electrochemically active material chosen from manganese dioxide (MnO₂), iron oxide, copper oxide, nickel oxide, lithium/manganese composite oxides (for example LiₓMn₂O₄ or LiₓMnO₂), lithium/nickel composition oxides (for example LiₓNiO₂), lithium/cobalt composition oxides (for example LiₓCoO₂), lithium/nickel/cobalt composite oxides (for example LiNi_{1-y}Co_{y}O2), lithium/nickel/cobalt/manganese composite oxides (for example LiNiₓMn_{y}Co_{z}O₂ with x+y+z=1), lithium-enriched lithium/nickel/cobalt/manganese composite oxides (for example Li₁₊ₓ(NiMnCo)₁₋ₓO₂), lithium/transition metal composite oxides, lithium/manganese/nickel composite oxides of spinel structure (for example LiₓMn_{2-y}Ni_{y}O₄), lithium/phosphorus oxides of olivine structure (for example LiₓFePO₄, LiₓFe_{1-y}Mn_{y}PO₄ or LiₓCoPO₄), iron sulfate, vanadium oxides, and mixtures thereof.

Preferably, the positive electrode comprises an electrochemically active material chosen from LiCoO₂, LiFePO₄ (LFP), LiMnₓCo_{y}Ni_{z}O₂ (NMC, with x+y+z=1), LiFePO₄F, LiFeSO₄F, LiNiCoAlO₂ and mixtures thereof.

The material of the positive electrode can also comprise, besides the electrochemically active material, an electronic conductor material, such as a carbon source, including, for example, carbon black, Ketjen® carbon, Shawinigan carbon, graphite, graphene, carbon nanotubes, carbon fibers (such as vapor-grown carbon fibers (VGCF)), non-powdery carbon obtained by carbonization of an organic precursor, or a combination of two or more of these. Other additives can also be present in the material of the positive electrode, such as lithium salts or inorganic particles of ceramic or glass type, or also other compatible active materials (for example sulfur).

The material of the positive electrode can also comprise a binder. Nonlimiting examples of binders comprise linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as SBR (styrene/butadiene rubber), NBR (acrylonitrile/butadiene rubber), HNBR (hydrogenated NBR), CHR (epichlorohydrin rubber), ACM (acrylate rubber)), or binders of fluoropolymer type (such as PVDF (polyvinylidene fluoride), PTFE (polytetrafluoroethylene)), and combinations thereof. Some binders, such as those which are soluble in water, can also comprise an additive, such as CMC (carboxymethylcellulose).

### Uses

The present application also relates to the use of an electrolyte composition as defined above, in a battery, in particular a Li-ion battery, said battery preferably comprising a negative electrode based on lithium, and in particular based on lithium metal.

These batteries can be used in mobile devices, for example mobile phones, cameras, tablets or laptops, in electric vehicles, or in the storage of renewable energy.

The present invention also relates to the use of the electrolyte composition as described above in an electrochemical cell comprising at least one negative electrode comprising lithium, and in particular lithium metal, for reducing or eliminating the growth of lithium dendrites on the surface of said electrode.

The electrolyte composition according to the invention advantageously makes it possible to reduce, or even eliminate, the formation of lithium dendrites in an electrochemical cell comprising lithium as electrochemically active anode material. This advantageously makes it possible to reduce the risk of internal short circuits and therefore to improve the life of the battery.

In the context of the invention, the term “of between x and y” or “between x and y” is intended to mean an interval wherein the limits x and y are included. For example, the range “of between 85% and 100%” or “from 85% to 100%” includes in particular the values 85% and 100%.

All the embodiments described above can be combined with one another.

The following examples illustrate the invention without, however, limiting it.

### EXPERIMENTAL SECTION

### Abbreviations

EC: ethylene carbonate
EMC: ethyl methyl carbonate (CAS 623-53-0)
FEC: fluoroethylene carbonate

### DO: Dioxolane

### DME: Dimethoxyethane

All of these above reagents are sold by BASF Corporation.
The LiFSI used is obtained in particular by the process described in the application WO2015/158979, while the LiTDI results from the process described in the application WO2013/072591.

### Example 1: Electrolyte Production

The following electrolytes were prepared:
composition 1 (according to the invention): 1 M LiFSI, 0.05 M LiTDI and 0.10 M LiNO₃, 3/7 (volume ratio) EC/EMC solvent mixture, 2% by weight of FEC (relative to the total weight of the EC/EMC solvent mixture);
composition 2 (according to the invention): 1 M LiFSI, 0.05 M LiTDI and 0.1 M LiNO₃, 1/3 (ratio by weight) DOL/DME solvent mixture, 2% by weight of FEC (relative to the total weight of the DOL/DME solvent mixture);
composition 3 (according to the invention): 1 M LiFSI, 0.05 M LiTDI and 0.1 M LiNO₃, in DME, 2% by weight of FEC (based on the total weight of DME);
composition 4 (according to the invention): 1.5 M LiFSI, 0.05 M LiTDI and 0.1 M LiNO₃, in DME, 2% by weight of FEC (based on the total weight of DME);
composition 5 (according to the invention): 2 M LiFSI, 0.05 M LiTDI and 0.1 M LiNO₃, in DME, 2% by weight of FEC (based on the total weight of DME);
composition 6 (according to the invention): 4 M LiFSI, 0.05 M LiTDI and 0.1 M LiNO₃, in DME, 2% by weight of FEC (based on the total weight of DME);
composition 7 (comparative): 1 M LiFSI in DME;
composition 8 (comparative): 1 M LiFSI, 0.05 M LiTDI, in DME, 2% by weight of FEC (based on the total weight of DME);
composition 9 (comparative): 1 M LiFSI, 0.1 M LiNO₃, in DME, 2% by weight of FEC (based on the total weight of DME);
composition 10 (comparative): 1 M LiFSI, 0.05 M LiTDI and 0.1 M LiNO₃, in DME.
   The compositions were prepared according to the following procedure:
   The solvents are mixed in a glass reaction vessel. After obtaining a homogeneous solution, Fluoroethylene carbonate (FEC) was added. Then the lithium salts were dissolved in the solution previously obtained.

### Example 2: Dendrite Test

A dendrite test was carried out with compositions 3, 7, 8, 9 and 10 prepared in example 1.
Method: the method consists in charging and discharging a symmetrical Li metal/Li metal battery; the potential of the battery is then measured. This potential is proportional to the surface area of the electrodes, therefore the appearance of dendrites results in an increase in potential.

### System Used:

Cathode: Lithium metal
Anode: Lithium metal
The battery is charged using a positive current of 0.25 mA to an energy density of 0.25 mAh.
The battery is then discharged using a negative current of 0.25 mA to an energy density of 0.25 mAh.

### Results:

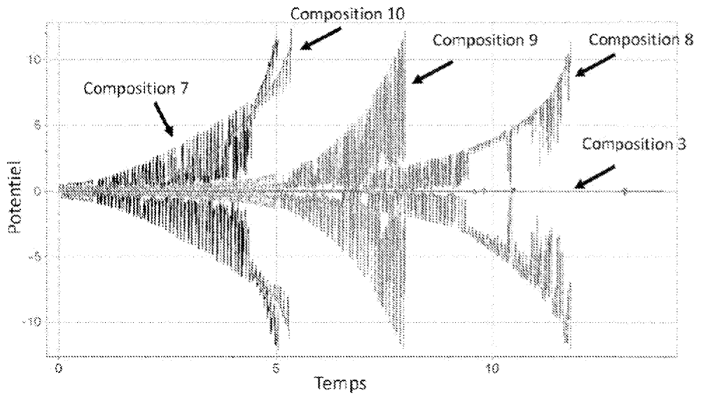

FIG. 1 shows the potential (in e/V) as a function of time (in days) for compositions 3, 7, 8, 9 and 10.
FIG. 1 shows that the potential increases with time for comparative compositions 7, 8, 9 and 10, which reflects the formation of lithium dendrites. Conversely, this is not the case for composition 3 according to the invention, which advantageously reflects the absence of formation of lithium dendrites.
The electrolyte 3 according to the invention can advantageously be used in a battery comprising a lithium metal anode without risk to safety, and with a better battery life.

1. An electrolyte composition comprising:
lithium 2-trifluoromethyl-4,5-dicyanoimidazolate,
lithium bis(fluorosulfonyl)imide,
lithium nitrate,
at least one additive allowing formation of an SEI passivation layer, and
at least one non-aqueous solvent.

2. The composition as claimed in claim 2, wherein the additive is in the group consisting of fluoroethylene carbonate, vinylene carbonate, difluoroethylenecarbonate, 4-vinyl-1,3-dioxolan-2-one, pyridazine, vinyl pyridazine, quinoline, vinyl quinoline, butadiene, sebaconitrile, alkyl disulfides, fluorotoluene, 1,4-dimethoxytetrafluorotoluene, t-butylphenol, di-t-butylphenol, tris(pentafluorophenyl)borane, oximes, aliphatic epoxides, halogenated biphenyls, methacrylic acids, allylethyl carbonate, vinyl acetate, divinyl adipate, acrylonitrile, 2-vinylpyridine, maleic anhydride, methyl cinnamate, phosphonates, vinyl-containing silane compounds, 2-cyanofuran, lithium bis(oxalato)borate, lithium difluoro(oxalato)borate, LiPO₂F₂, and mixtures thereof.

3. The composition as claimed in claim 1, wherein the additive is chosen from the group consisting of fluoroethylene carbonate, vinylene carbonate, lithium difluorooxalato borate, LiPO₂F₂, and mixtures thereof.

4. The composition as claimed in claim 1, wherein the total weight content of additive(s) ranges from 0.01% to 10% by weight relative to the total weight of the composition.

5. The composition as claimed in claim 1, wherein the molar concentration of lithium 2-trifluoromethyl-4,5-dicyanoimidazolate in the electrolyte composition is less than or equal to 3 mol/l.

6. The composition as claimed in claim 1, wherein the molar concentration of lithium bis(fluorosulfonyl)imide in the electrolyte composition is less than or equal to 5 mol/l.

7. The composition as claimed in claim 1, wherein the molar concentration of lithium nitrate in the electrolyte composition is less than or equal to 3 mol/l.

8. The composition as claimed in claim 1, wherein the molar concentrations of lithium nitrate, lithium 2-trifluoromethyl-4,5-dicyanoimidazolate and lithium bis(fluorosulfonyl)imide are such that:
[LiFSI]+[LiTDI]+[LiNO₃]≤5 mol/l
advantageously less than or equal to 4 mol/l.

9. The composition as claimed in claim 1, wherein the non-aqueous solvent is chosen from the group consisting of ethers, carbonates, ketones, partially hydrogenated hydrocarbons, nitriles, amides, sulfoxides, sulfolane, nitromethane, 1,3-dimethyl-2-imidazolidinone, 1,3-dimethyl-3,4,5,6-tetrahydro-2(1H)-pyrimidinone, 3-methyl-2-oxazolidinone and mixtures thereof.

10. An electrochemical cell comprising a negative electrode, a positive electrode and an electrolyte composition as defined here in claim 1.

11. The electrochemical cell as claimed in claim 10, wherein the negative electrode comprises lithium as electrochemically active material.

12. A battery comprising at least one electrochemical cell as claimed in claim 10.

13. A method comprising reducing or eliminating the growth of lithium dendrites on the surface of a negative electrode by using the electrolyte composition as claimed in claim 1 in an electrochemical cell comprising at least one negative electrode comprising lithium.
